(19) United States
(12) Patent Application Publication
(10) Pub. No.: US 2025/0058395 A1
(43) Pub. Date: Feb. 20, 2025

(54) ARC ADDITIVE APPARATUS, CONTROL METHOD FOR THE ARC ADDITIVE APPARATUS, AND STORAGE MEDIUM

(71) Applicant: WUYI UNIVERSITY, Jiangmen (CN)

(72) Inventors: Ruichao WANG, Jiangmen (CN); Hao WANG, Jiangmen (CN); Yuebang HE, Jiangmen (CN); Xiang GAO, Jiangmen (CN); Chuanqi CAI, Jiangmen (CN); Huijun LI, Jiangmen (CN)

(21) Appl. No.: 18/724,859

(22) PCT Filed: Jun. 23, 2022
(86) PCT No.: PCT/CN2022/100855

§ 371 Date: Jun. 27, 2024

(30) Foreign Application Priority Data
Jun. 8, 2022 (CN) 2022106396986

(51) Int. Cl. B23K 9/04; B33Y 30/00; B33Y 50/02

(52) U.S. Cl. CPC B23K 9/042; B33Y 30/00; B33Y 50/02

(57) ABSTRACT

An arc additive apparatus, a control method for an arc additive apparatus, and a storage medium are disclosed. The arc additive apparatus includes: an additive welding gun, configured to melt a wire to perform additive manufacturing on a workpiece to be machined; a mechanical vibration device, arranged below the workpiece; an ultrasonic auxiliary device, arranged at a side of the additive welding gun; and a control device, configured to control the ultrasonic auxiliary device to form an ultrasonic field below the additive welding gun, and to control, when welding at a position where additive manufacturing is to be performed by the additive welding gun, the mechanical vibration device to perform a mechanical vibration in different modes separately during and at the end of a welding process of the additive welding gun.

### CROSS-REFERENCE TO RELATED APPLICATIONS

This application is a national stage filing under 35 U.S.C. § 371 of international application number PCT/CN2022/100855, filed Jun. 23, 2022, which claims priority to Chinese patent application No. 202210639698.6 filed Jun. 8, 2022. The contents of these applications are incorporated herein by reference in their entirety.

### TECHNICAL FIELD

The present disclosure relates to the field of additive manufacturing, and in particular, to an arc additive apparatus, a control method for the arc additive apparatus, and a storage medium.

### BACKGROUND

Additive manufacturing technology is a revolutionary manufacturing technology that overturns traditional subtractive manufacturing methods. In particular, metal additive manufacturing, as a revolutionary and advanced manufacturing technology, is widely applied in fields such as aerospace, biomedical, industrial molds, and power energy.

The arc additive manufacturing technology involves melting a wire through an arc, and stacking the molten metal layer by layer in a form of line-plane-solid according to the three-dimensional model of a product to form a metal part after solidifying. However, in the arc additive process, the thermal input is high, leading to significant additive processing stress in the workpiece, making the product obtained by the arc additive manufacturing prone to cracks.

### SUMMARY

The present disclosure aims to solve at least one of the technical problems in the existing technology. To this end, the present disclosure proposes arc additive apparatus, a control method for an arc additive apparatus, and a storage medium, which can diminish the thermal stress accumulated in the workpiece during the additive manufacturing, and further diminish the residual stress in the workpiece after the additive manufacturing is completed.

In a first aspect, the present disclosure provides arc additive apparatus, including:
an additive welding gun, configured to melt a wire to perform additive manufacturing on a workpiece to be machined;
a mechanical vibration device, arranged below the workpiece;
an ultrasonic auxiliary device, arranged at a side of the additive welding gun; and
a control device, electrically connected to the additive welding gun, the mechanical vibration device and the ultrasonic auxiliary device and configured to control the ultrasonic auxiliary device to form an ultrasonic field below the additive welding gun, and to control, when welding at a position where additive manufacturing is to be performed by the additive welding gun, the mechanical vibration device to perform a mechanical vibration in different modes separately during and at the end of a welding process of the additive welding gun.

The control method for the arc additive apparatus provided according to the first aspect of the present disclosure has at least the following beneficial effects. The arc additive apparatus includes the additive welding gun, the mechanical vibration device, the ultrasonic auxiliary device and the control device. The control device controls the ultrasonic auxiliary device to form the ultrasonic field below the additive welding gun. When welding at a position where additive manufacturing is to be performed by the additive welding gun, the control device controls the mechanical vibration device to perform the mechanical vibration in different modes separately during and at the end of the welding process of the additive welding gun. In the welding process of the additive welding gun, the mechanical vibration can reduce the accumulation of thermal stress, and after the additive welding gun finishes working, stress generated by another mode of mechanical vibration is superimposed on the residual stress in the workpiece, which can further diminish the residual stress in the workpiece. The two different modes of mechanical vibration cooperating with each other can reduce the stress in the workpiece significantly, and minimize the occurrence of cracks in products using arc additive manufacturing, thus improving the quality of the products.

According to some embodiments of the first aspect of the present disclosure, the arc additive apparatus further includes a frequency conversion control cabinet and an electric cylinder, a signal transmitting end of the frequency conversion control cabinet is connected to the mechanical vibration device, a drive end of the electric cylinder is connected to the mechanical vibration device, and both the frequency conversion control cabinet and the electric cylinder are electrically connected to the control device.

According to some embodiments of the first aspect of the present disclosure, the mechanical vibration device includes at least one motor and at least one vibrator, the motor is connected to the vibrator and the signal transmitting end of the frequency conversion control cabinet, and the other end of the vibrator is connected to the workpiece.

According to some embodiments of the first aspect of the present disclosure, a molding table is provided between the vibrator and the workpiece.

In a second aspect, the present disclosure provides a control method for an arc additive apparatus, the arc additive apparatus including an additive welding gun, a mechanical vibration device and an ultrasonic auxiliary device, the ultrasonic auxiliary device is arranged at a side of the additive welding gun, and the control method includes:
acquiring an additive instruction;
controlling the ultrasonic auxiliary device to emit ultrasonic waves according to the additive instructions, to form an ultrasonic field below the additive welding gun;
controlling the ultrasonic field to move along a workpiece where additive manufacturing is to be performed;
controlling, in a process that the additive welding gun welds the workpiece, the mechanical vibration device to provide a mechanical vibration for the workpiece according to a first mode; and
controlling, after the additive welding gun finishes welding, the mechanical vibration device to provide a mechanical vibration for the workpiece according to a second mode, where the second mode indicates mechanical vibration parameters different from the first mode.

Since the control method for the arc additive apparatus provided in the second aspect is applied to the arc additive apparatus according to any embodiment in the first aspect, the control method has the beneficial effects of the first aspect of the present disclosure.

According to some embodiments of the second aspect of the present disclosure, the mechanical vibration parameters include a frequency and an amplitude, the frequency of the second mode is less than that of the first mode, and the amplitude of the second mode is greater than that of the first mode.

According to some embodiments of the second aspect of the present disclosure, the arc additive apparatus further includes a frequency conversion control cabinet and an electric cylinder,
the controlling the mechanical vibration device to provide a mechanical vibration for the workpiece according to a first mode includes:

adjusting by the frequency conversion control cabinet the frequency at which the mechanical vibration device performs the mechanical vibration to be a first frequency, where the first frequency is the frequency of the first mode; and
adjusting by the electric cylinder the amplitude at which the mechanical vibration device performs the mechanical vibration to be a first amplitude, where the first amplitude is the amplitude of the first mode;
the controlling the mechanical vibration device to provide a mechanical vibration for the workpiece according to a second mode includes:
adjusting by the frequency conversion control cabinet the frequency at which the mechanical vibration device performs the mechanical vibration to be a second frequency, where the second frequency is the frequency of the second mode; and
adjusting by the electric cylinder the amplitude at which the mechanical vibration device performs the mechanical vibration to be a second amplitude, where the second amplitude is the amplitude of the second mode.

According to some embodiments of the second aspect of the present disclosure, the first frequency ranges from 100 Hz to 150 Hz, and the first amplitude ranges from 50 microns to 80 microns.

According to some embodiments of the second aspect of the present disclosure, the second frequency ranges from 20 Hz to 50 Hz, the second amplitude ranges from 100 microns to 200microns, and the mechanical vibration in the second mode lasts for 30 s to 60 s.

In a third aspect, the present disclosure provides a computer storage medium, including computer-executable instructions stored therein, where the computer-executable instructions are used to execute the control method for the arc additive apparatus according to the first aspect of the present disclosure.

Since the computer storage medium of the third aspect can execute the control method for the arc additive apparatus according to any embodiment in the second aspect, the computer storage medium has the beneficial effects of the first aspect of the present disclosure.

### BRIEF DESCRIPTION OF DRAWINGS

In order to more clearly illustrate the technical solution in the embodiments of the present disclosure, the accompanying drawings required to be used in the description of the embodiments or related art will be briefly introduced below. Apparently, the accompanying drawings described below are only some embodiments of the present disclosure. Those of ordinary skill in the art can also obtain other accompanying drawings based on these drawings without making creative efforts.

FIG. 1 is a structural block diagram of arc additive apparatus provided in an embodiment of the present disclosure;

FIG. 2 is a schematic structural diagram of the arc additive apparatus provided in an embodiment of the present disclosure;

FIG. 3 is a schematic structural diagram of a mechanical vibration device of the arc additive apparatus provided in an embodiment of the present disclosure;

FIG. 4 is a flowchart of the main steps of a control method for the arc additive apparatus provided in an embodiment of the present disclosure;

FIG. 5 is a flowchart of mechanical vibration adjustment in a first mode of the control method for the arc additive apparatus provided in an embodiment of the present disclosure; and

FIG. 6 is a flowchart of mechanical vibration adjustment in a second mode of the control method for the arc additive apparatus provided in an embodiment of the present disclosure.

Reference numerals: arc additive apparatus 100; additive welding gun 110; mechanical vibration device 120; motor 121; vibrator 122; coupling 123; camshaft 124; slider 125; ultrasonic auxiliary device 130; ultrasonic generator 131; ultrasonic transducer 132; amplitude transformer 133; control device 140; industrial computer 141; frequency conversion control cabinet 150; electric cylinder 160; flange 161; molding table 171; substrate 172; workpiece 173; wire feeder 174; welding machine 175; and gas cylinder 176.

### DETAILED DESCRIPTION

In the following description, for the purpose of explanation rather than limitation, specific details such as specific system structures and technologies are provided for ease of a thorough understanding of the embodiments of the present disclosure. However, it will be apparent to those of ordinary skills in the art that the embodiments of the present disclosure may also be implemented in other embodiments without these specific details. In other cases, detailed descriptions of well-known systems, devices, circuits and methods are omitted so as not to obstruct the description of the embodiments of the present disclosure with unnecessary details.

It should be noted that although a logical sequence is shown in the flowchart, in some cases, the presented or described steps may be performed in a sequence different from that described here. Terms “first”, “second” and the like in the description, claims and the above accompanying drawings are used to distinguish between similar objects, and do not need to be used to describe a specific sequence or precedence order.

It should also be understood that reference to “an embodiment” or “some embodiments” and the like in the description of the embodiments of the present disclosure means that the specific features, structures and characteristics described in combination with the embodiment(s) are included in one or more of the embodiments of the present disclosure. Therefore, the statements “in an embodiment”, “in some embodiments”, “in other embodiments”, “in another embodiment” and the like appearing in different positions in this description do not necessarily refer to the same embodiment, but rather to “one or more but not all embodiments”, unless specifically stated otherwise. The terms “including/comprising”, “containing”, “having”, and variations thereof all mean “including but not limited to”, unless specifically emphasized otherwise.

In the description of the present disclosure, greater than, less than, exceeding and the like are understood as excluding the specified number, and above, below, within and the like are understood as including the specified number. If described, first and second are merely used for distinguishing technical features, instead of is understood as indicating or implying relative importance or impliedly indicating the quantity of the showed technical features or impliedly indicating the precedence relationship of the showed technical features. It should be understood that orientation or position relationships related to orientation descriptions, such as up, down, front, back, left, right, etc. are based on the orientation or position relationships as shown in the accompanying drawings, for ease of describing the present disclosure and simplifying the description only, rather than indicating or implying that the device or element referred to must have a specific orientation, be constructed and operate in a specific orientation, and therefore cannot be construed as a limitation on the present disclosure.

Additive manufacturing technology is a revolutionary manufacturing technology that overturns traditional subtractive manufacturing methods. In particular, metal additive manufacturing, as a revolutionary and advanced manufacturing technology, is widely applied in fields such as aerospace, biomedical, industrial molds, and power energy. At present, the metal additive technology is mainly divided into laser additive manufacturing and arc additive manufacturing. Laser additive manufacturing has the advantages of good molding effect, high precision and the like, but it produces smaller workpieces and has slower molding speed, making it suitable primarily for manufacturing more precise workpieces. The arc additive manufacturing technology is a process in which the wire is melted by an arc, and the molten metal is stacked layer by layer according to the three-dimensional model of the product, and solidified to form the metal part. The manufacturing of large-sized workpieces may be implemented by the arc additive manufacturing technology, and the manufacturing speed thereof is much faster than that of the laser additive manufacturing. However, the manufacturing apparatus used in the arc additive process has low precision, resulting in large surface roughness of the parts. Additionally, the heat input in the manufacturing process is high, leading to significant processing stress in the products and making them prone to cracking and other defects.

On this basis, embodiments of the present disclosure provide an arc additive apparatus, a control method for the arc additive apparatus, and a storage medium. During and at the end of the working of the additive welding gun, the two different modes of mechanical vibration are carried out on the workpiece according to the control method for the arc additive apparatus provided in the embodiments of the present disclosure, so as to reduce the stress in the workpiece significantly, and minimize the occurrence of cracks in arc additive products, thus improving the quality of products.

The embodiments of the present disclosure will be further described below with reference to the accompanying drawings.

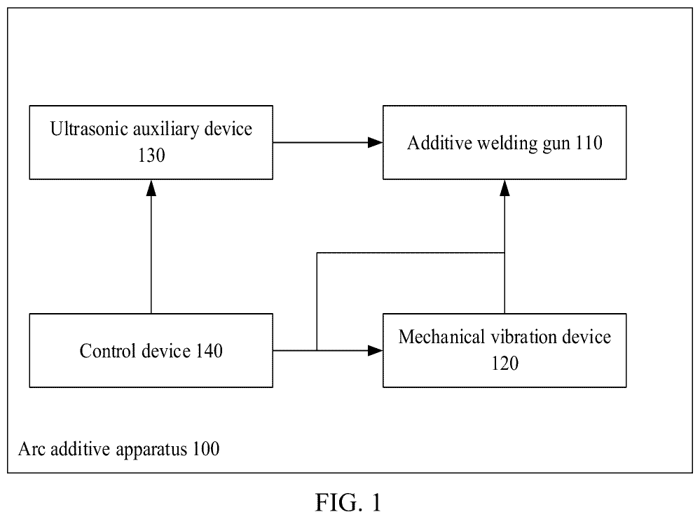

Referring to FIG. 1, which is a structural block diagram of an arc additive apparatus 100 provided in an embodiment of the present disclosure. In the example of FIG. 1, the arc additive apparatus 100 includes an additive welding gun 110, a mechanical vibration device 120, an ultrasonic auxiliary device 130, and a control device 140.

The additive welding gun 110 is configured to melt a wire to perform additive manufacturing on a workpiece 173 to be machined.

The mechanical vibration device 120 is arranged below the workpiece 173 and configured to provide a mechanical vibration for the workpiece 173.

The ultrasonic auxiliary device 130 is arranged at a side of the additive welding gun 110 and configured to adjust a droplet transfer process of the wire, and can stir a molten pool formed by the melting of the wire.

The control device 140 is electrically connected to the additive welding gun 110, the mechanical vibration device 120 and the ultrasonic auxiliary device 130 respectively, and the control device 140 is configured to control the ultrasonic auxiliary device 130 to form an ultrasonic field below the additive welding gun 110, and to control, when welding at a position where additive manufacturing is to be performed by the additive welding gun 110, the mechanical vibration device 120 to perform the mechanical vibration in different modes separately during and at the end of a welding process of the additive welding gun 110.

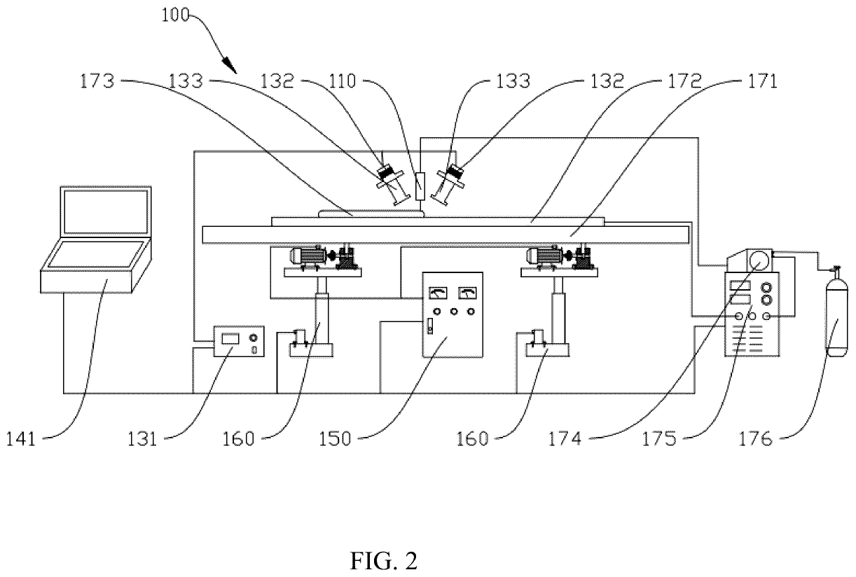

It should be noted that, referring to FIG. 2, the control device 140 in the embodiment of the present disclosure is an industrial computer 141.

In this embodiment, the additive welding gun 110 melts the wire to perform additive manufacturing on the workpiece 173 to be machined. The control device 140 controls the ultrasonic auxiliary device 130 to emit ultrasonic waves to the melting position of the wire during the additive manufacturing, that is, below the additive welding gun 110, so as to adjust the droplet transfer process of the wire and stir the molten pool formed by the melting of the wire. In addition, the control device 140 controls the mechanical vibration device 120 to provide the mechanical vibration for the workpiece 173 in different modes separately during and at the end of the welding process of the additive welding gun 110. When the additive welding gun 110 is in a working status, the mechanical vibration can reduce the accumulation of thermal stress. After the additive welding gun 110 finishes working, the stress generated by another mode of mechanical vibration is superimposed on the residual stress in the workpiece 173, which can further diminish the residual stress in the workpiece 173. The two different modes of mechanical vibration cooperating with each other can significantly reduce the stress in the workpiece 173 significantly, and minimize the occurrence of cracks in products using arc additive manufacturing, thus improving the quality of the products.

It can be understood that a substrate 172 is provided between the workpiece 173 and the ultrasonic auxiliary device 130. The workpiece 173 is usually placed on the substrate 172, and the additive welding process is also performed on the substrate 172.

It can be understood that, referring to FIG. 2, the arc additive apparatus 100 further includes a frequency conversion control cabinet 150 and an electric cylinder 160. A signal transmitting end of the frequency conversion control cabinet 150 is connected to the mechanical vibration device 120. A drive end of the electric cylinder 160 is connected to the mechanical vibration device 120. Both the frequency conversion control cabinet 150 and the electric cylinder 160 are electrically connected to the control device 140.

It should be noted that the control device 140 controls, according to the acquired working status of the additive welding gun 110, the frequency conversion control cabinet 150 to adjust the frequency of the mechanical vibration, and adjusts the amplitude of the mechanical vibration through the electric cylinder 160.

It should be noted that the frequency conversion control cabinet 150 can adjust the rotating speed of a motor 121, thus adjusting the frequency of the mechanical vibration between the vibrator 122 and the workpiece 173.

It should be noted that, referring to FIG. 2, the electric cylinder 160 is provided below the mechanical vibration device 120, and the electric cylinder 160 is configured to adjust the distance between the mechanical vibration device 120 and the workpiece 173.

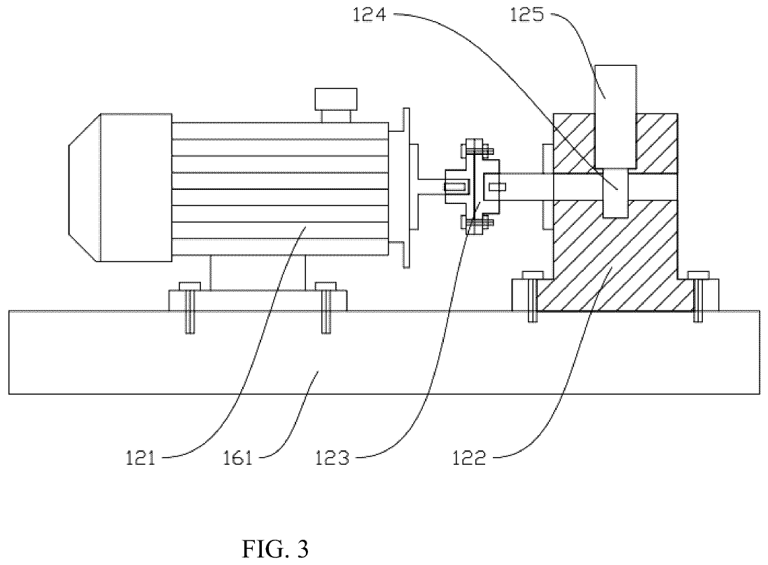

It should be noted that, referring to FIGS. 2 and 3, the mechanical vibration device 120 is provided on a flange 161 of the electric cylinder 160. By moving the electric cylinder 160 up and down, the distance between the mechanical vibration device 120 and the workpiece 173 can be adjusted, thus adjusting the amplitude of the mechanical vibration.

It can be understood that, referring to FIGS. 2 and 3, the mechanical vibration device 120 includes at least one motor 121 and at least one vibrator 122. The motor 121 is connected to the vibrator 122 and the signal transmitting end of the frequency conversion control cabinet 150, and the other end of the vibrator 122 is connected to the workpiece 173.

It should be noted that the quantities of the motor 121 and the vibrator 122 are not limited, and the specific quantities need to enable the mechanical vibration generated by the mechanical vibration device 120 to evenly cover the entire workpiece 173. In addition, since the workpiece 173 is arranged on the substrate 172, the quantities of the motor 121 and the vibrator 122 are also limited by the length of the substrate 172.

It should be noted that, referring to FIG. 3, the motor 121 is connected to the vibrator 122 through a coupling 123, and the vibrator 122 include a slider 125 and a camshaft 124. Rotation of the motor 121 drives the camshaft 124 to rotate, such that the slider 125 fixed to the camshaft 142 continuously make reciprocating motion and collide with the workpiece 173, thereby generating the mechanical vibration. In the embodiments of the present disclosure, a time interval between collisions of the slider 125 with the workpiece 173 is adjusted by adjusting the rotating speed of the motor 121, thereby adjusting the frequency of the mechanical vibration.

It can be understood that, referring to FIG. 2, a molding table 171 is provided between the vibrator 122 and the workpiece 173.

It should be noted that the processing and additive manufacturing of the workpiece 173 are performed on the substrate 172, and the molding table 171 is provided between the substrate 172 and the vibrator 122. The setting of the molding table 171 enables the mechanical vibration delivered to the workpiece 173 by the vibrator 122 to be buffered, so that the mechanical vibration can act on the workpiece 173 more uniformly, and the final product obtained by the arc additive exhibits similar properties throughout and has improved mechanical properties.

It can be understood that, referring to FIG. 2, the ultrasonic auxiliary device 130 includes an ultrasonic generator 131 and two ultrasonic transducers 132. The two ultrasonic transducers 132 are arranged on opposite sides of the additive welding gun 110 to enhance the ultrasonic field at the droplet transfer position. The signal transmitting end of the ultrasonic generator 131 is connected to the two ultrasonic transducers 132, and the ultrasonic generator 131 is connected to the control device 140.

It should be noted that, according to the melting process of the wire, the ultrasonic generator 131 is controlled to drive the two ultrasonic transducers 132 to emit ultrasonic waves to the melting position of the wire, so that an ultrasonic field is formed at the melting position of the wire, so as to regulate the droplet transfer of the wire, further enhancing the stability in the additive welding process and improving the additive efficiency and additive quality. Meanwhile, part of the ultrasonic waves emitted by the ultrasonic transducers 132 will enter the molten pool, which can reduce bubbles during the additive manufacturing and continuously break large crystal grains in the workpiece 173, so that the crystal grains in the workpiece 173 are continuously refined.

It should be noted that, according to the melting process of the wire, the ultrasonic frequency emitted by the ultrasonic auxiliary device 130 ranges from 20 kilohertz to 25 kilohertz.

It can be understood that, referring to FIG. 2, the ultrasonic auxiliary device 130 further includes two amplitude transformers 133, which are connected to the transmitting ends of the corresponding ultrasonic transducers 132, respectively, and both the transmitting ends of the amplitude transformers 133 are concave arc surfaces.

It should be noted that the setting of the amplitude transformers 133 helps gather and transmit the ultrasonic energy of the ultrasonic waves emitted by the ultrasonic transducers 132, and the transmitting ends of the amplitude transformers 133 are concave arc surfaces, which better facilitates the gathering and transmitting of the ultrasonic energy.

It should be noted that the ultrasonic waves emitted by the ultrasonic transducers 132 are gathered and transmitted to the melting position of the wire by the amplitude transformers 133, which further enhances the ultrasonic field formed by the ultrasonic transducers 132, allowing ultrasonic transducers 132 to regulate the droplet transfer of the wire, thus further enhancing the stability of the additive welding process, and improving the additive efficiency and additive quality.

It can be understood that both ultrasonic transducers 132 are fixedly connected to the additive welding gun 110.

It should be noted that both ultrasonic transducers 132 are fixedly connected to the additive welding gun 110, ensuring that the relative position between the ultrasonic transducers 132 and the additive welding gun 110 remains unchanged. Consequently, the parameters, at the melting position of the wire, of the ultrasonic waves emitted by the ultrasonic auxiliary device 130 remain unchanged, which ensures the stability of the additive welding process and is conducive to improving the quality of the workpiece 173.

It can be understood that, referring to FIG. 2, the arc additive apparatus 100 provided in an embodiment of the present disclosure further includes a welding machine 175 and a wire feeder 174. One end of the wire feeder 174 is connected to the additive welding gun 110 through a pipeline, the wire feeder 174 is configure to deliver the wire to the additive welding gun 110 through the pipeline, the wire feeder 174 is connected to the welding machine 175, and the welding machine 175 is electrically connected to the control device 140.

It should be noted that the wire feeder 174 is connected to the additive welding gun 110 through the pipeline, the wire sent out by the wire feeder 174 can be accurately delivered below the additive welding gun 110 through the pipeline, facilitating the later additive welding. The welding machine 175 mainly controls the waveform of arc current generated by the additive welding gun 110, and can regulate the peak current, pulse frequency, peak time and background current of the arc current. In addition, the welding machine 175 is also connected to the wire feeder 174 and can adjust the speed at which the wire feeder 174 delivers the wire.

It can be understood that, referring to FIG. 2, the arc additive apparatus 100 provided in an embodiment of the present disclosure further includes a gas cylinder 176 for providing inert gas. The gas cylinder 176 communicates with the additive welding gun 110.

It should be noted that the gas cylinder 176 may be connected to the additive welding gun 110 through a gas delivery pipe. Before the additive welding gun 110 works, the gas cylinder 176 is opened and the inert gas in the gas cylinder 176 is delivered to the additive welding gun 110, such that the inert gas coats the wire, melted droplets and molten pool. The continuous delivery of shielding gas from the beginning of welding can reduce the probability of oxidizing the molten pool when is cooled, thus reducing the probability of the occurrence of tissue deterioration and decrease of the mechanical property.

It should be noted that, referring to FIGS. 1 to 3, the arc additive apparatus 100 provided in an embodiment of the present disclosure includes an additive welding gun 110, a mechanical vibration device 120, an ultrasonic auxiliary device 130 and a control device 140. Before the additive welding gun 110 works, the gas cylinder 176 is opened so that the inert gas in the gas cylinder 176 is delivered to the additive welding gun 110, and the welding machine 175 controls the wire feeder 174 to deliver the wire below the additive welding gun 110, and then the additive welding gun 110 works to melt the wire and perform additive manufacturing on the workpiece 173 to be machined. The ultrasonic auxiliary device 130 drives the two ultrasonic transducers 132 to work through the bypass ultrasonic generator 131, so that the two ultrasonic transducers 132 transmit ultrasonic waves below the additive welding gun 110 to form an ultrasonic field and regulate the droplet transfer of the wire, which further enhances the stability in the additive welding process and improves the additive efficiency and additive quality. Meanwhile, part of the ultrasonic waves emitted by the ultrasonic transducers 132 will enter the molten pool to stir the molten pool, thus eliminating bubbles in the molten pool. Moreover, the large crystal grains during the solidification of the molten pool will be broken, to refine continuously the weld crystal grains, improving the mechanical properties of the weld and enhancing the quality of the workpiece 173. The mechanical vibration device 120 includes at least one motor 121 and at least one vibrator 122. The motor 121 is connected to the signal transmitting end of the frequency conversion control cabinet 150 and the vibrator 122, the other end of the vibrator 122 is connected to the workpiece 173, and the signal transmitting end of the frequency conversion control cabinet 150 is connected to the mechanical vibration device 120. The control device 140 controls, according to the obtained working status of the additive welding gun 110, the frequency conversion control cabinet 150 to adjust the frequency of the mechanical vibration, that is, the rotating speed of the motor 121 is adjusted by the frequency conversion control cabinet 150, and rotation of the motor 121 drives the camshaft 124 of the vibrator 122 to rotate, causing the slider 125 fixed to the camshaft 124 to continuously reciprocate and collide with the molding table 171 below the workpiece 173, thereby generating the mechanical vibration. In the embodiments of the present disclosure, the time interval between collisions of the slider 125 with the workpiece 173 is adjusted by adjusting the rotating speed of the motor 121, thereby adjusting the frequency of the mechanical vibration. The mechanical vibration device 120 is provided on a flange 161 of the electric cylinder 160. By moving the electric cylinder 160 up and down, the distance between the mechanical vibration device 120 and the workpiece 173 can be adjusted, thereby adjusting the amplitude of the mechanical vibration. The control device 140 controls the mechanical vibration device 120 to perform the mechanical vibration in different modes during and at the end of the welding process of the additive welding gun 110. The mechanical vibration can reduce the accumulation of thermal stress in the welding process of the additive welding gun 110. After the additive welding gun 110 finishes working, the stress generated by another mode of mechanical vibration is superimposed on the residual stress in the workpiece 173, which can further diminish the residual stress in the workpiece 173. The two different modes of mechanical vibration cooperating with each other can significantly reduce the stress in the workpiece 173, and minimize the occurrence of cracks in products using arc additive manufacturing, thus improving the quality of the products.

The devices and application scenarios described in the embodiments of the present disclosure are for the purpose of explaining the technical solutions of the embodiments of the present disclosure more clearly and do not constitute limitations on the technical solutions provided in the embodiments of the present disclosure. Those of ordinary skills in the art may know that, with the evolution of the system architecture and the emergence of new application scenarios, the technical solutions provided in the embodiments of the present disclosure are also applicable to similar technical problems.

Those of ordinary skills in the art may understand that the device structures shown in FIGS. 1 to 3 do not constitute limitations on the embodiments of the present disclosure, and may include more or less components than those as shown, or combine certain components, or have different component arrangements.

In the device structures shown in FIGS. 1 to 3, each module can separately call the control program of the arc additive apparatus 100 stored therein to execute the control method for the arc additive apparatus 100.

Based on the above devices, various embodiments of the control method for the arc additive apparatus 100 in the embodiments of the present disclosure are proposed.

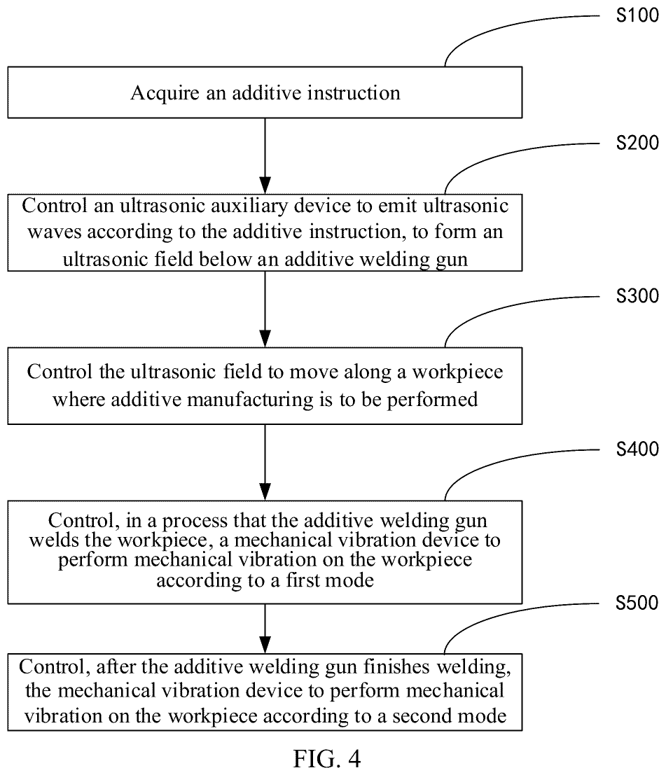

As shown in FIG. 4, which is a main step diagram of the control method for the arc additive apparatus 100 provided in an embodiment of the present disclosure, the arc additive apparatus 100 includes an additive welding gun 110, a mechanical vibration device 120 and an ultrasonic auxiliary device 130. The control method for the arc additive apparatus 100 includes but is not limited to the following steps.

At S100, an additive instruction is acquired.

It should be noted that the additive instruction comes from the setting of the control device in the arc additive apparatus and can be set manually.

It should be noted that the additive instruction corresponds to the respective workpiece 173. Different workpieces 173 require different parameters of the arc additive apparatus 100, and the corresponding additive instructions thereof are different.

At S200, the ultrasonic auxiliary device is controlled to emit ultrasonic waves according to the additive instruction, to form an ultrasonic field below the additive welding gun.

It should be noted that before the additive welding gun 110 works, the ultrasonic auxiliary device 130 is controlled to emit the ultrasonic waves below the additive welding gun 110 to form a stable ultrasonic field. The ultrasonic auxiliary device 130 can regulate the droplet transfer process of the wire, improving the additive efficiency and additive quality, and part of the energy of the ultrasonic field formed by the ultrasonic auxiliary device 130 enters the molten pool formed by the melting of the wire and is absorbed by the molten pool. The bubbles during the additive manufacturing are reduced due to the ultrasonic stirring effect, and the large crystal grains in the workpiece 173 are broken continuously, so that the crystal grains in the workpiece 173 are continuously refined, thus improving the mechanical properties and molding quality of the additive workpiece 173.

At S300, the ultrasonic field is controlled to move along a workpiece where additive manufacturing is to be performed.

It should be noted that since the ultrasonic field is formed below the additive welding gun 110, controlling the ultrasonic field to move along a workpiece where additive manufacturing is to be performed means that the additive welding gun 110 moves along the workpiece 173 where additive manufacturing is to be performed.

At S400, in a process that the additive welding gun welds the workpiece, the mechanical vibration device is controlled to provide a mechanical vibration for the workpiece 173 according to a first mode.

It should be noted that, in the process that the additive welding gun 110 welds the workpiece 173, the mechanical vibration device 120 performs the mechanical vibration for the workpiece 173 according to the first mode, and the mechanical vibration acts on a mesoscopic level, which can reduce the thermal stress accumulated in the formation process of the workpiece 173.

At S500, after the additive welding gun finishes welding, the mechanical vibration device is controlled to provide a mechanical vibration for the workpiece according to a second mode, where mechanical vibration parameters of the second mode are different from those of the first mode.

It should be noted that after the additive welding gun 110 finishes working, the ultrasonic auxiliary device 130 also needs to be turned off.

It should be noted that after the welding of the additive welding gun 110 is completed, the mechanical vibration in the first mode cannot completely eliminate the thermal stress in the workpiece 173, and the mechanical vibration in the second mode has different frequency and amplitude from the mechanical vibration in the first mode, thus further diminishing the residual stress in the workpiece 173.

It should be noted that, before the additive welding gun 110 works, the ultrasonic auxiliary device 130 transmits ultrasonic waves below the additive workpiece 173 to form a stable ultrasonic field, the ultrasonic auxiliary device 130 regulates the droplet transfer process of the wire through the ultrasonic field to improve the additive efficiency and additive quality, and part of the energy of the ultrasonic field formed by the ultrasonic auxiliary device 130 enters the molten pool formed by the melting of the wire, and is absorbed by the molten pool. The bubbles during the additive manufacturing are reduced due to the ultrasonic stirring effect, and the large crystal grains in the workpiece 173 are broken continuously, so that the crystal grains in the workpiece 173 are continuously refined, thus effectively improving the quality of the arc additive and the stability of the additive process. In the welding process of the additive welding gun 110, the mechanical vibration device 120 is controlled to provide the mechanical vibration for the workpiece 173 according to the first mode. The amplitude of the mechanical vibration is relatively large, and the mechanical vibration acts on the mesoscopic level to reduce the accumulation of thermal stress during the additive manufacturing. After the welding of the additive welding gun 110 is completed, the mechanical vibration device 120 is controlled to provide the mechanical vibration for the workpiece 173 according to the second mode. The mechanical vibration parameters of the second mode are different from those of the first mode, and the mechanical vibration of the second mode can further diminish the residual stress in the workpiece 173. The mechanical vibrations of the first mode and the second mode cooperating with each other can reduce the stress in the workpiece 173 significantly, minimize the occurrence of cracks in products using arc additive manufacturing, and enhance the mechanical properties of the workpiece 173, thus improving the quality of the products.

It can be understood that the mechanical vibration parameters include a frequency and an amplitude. The frequency of the second mode is less than that of the first mode, and the amplitude of the second mode is greater than that of the first mode.

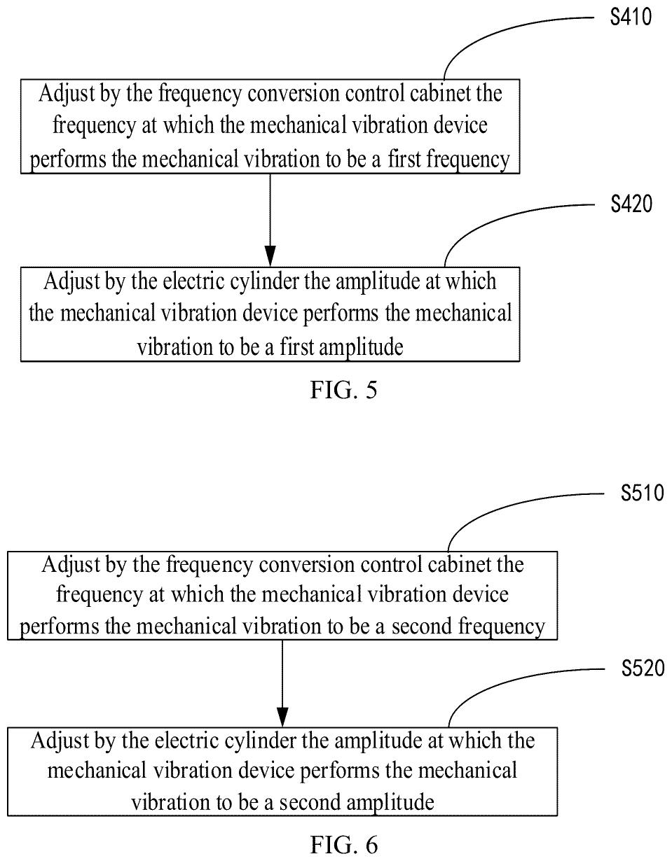

It can be understood that, referring to FIG. 5, which is a flowchart of mechanical vibration adjustment in a first mode of the control method for the arc additive apparatus 100 provided in an embodiment of the present disclosure, step S400 includes but is not limited to the following steps.

At S410, the frequency at which the mechanical vibration device performs mechanical vibration is adjusted by the frequency conversion control cabinet to be a first frequency, where the first frequency is the frequency of the first mode.

At S420, the amplitude at which the mechanical vibration device performs mechanical vibration is adjusted by the electric cylinder to be a first amplitude, where the first amplitude is the amplitude of the first mode.

Referring to FIG. 6, which is a flowchart of mechanical vibration adjustment in a second mode of the control method for the arc additive apparatus 100 provided in an embodiment of the present disclosure, step S500 includes but is not limited to the following steps.

At S510, the frequency at which the mechanical vibration device performs mechanical vibration is adjusted by the frequency conversion control cabinet to be a second frequency, where the second frequency is the frequency of the second mode.

At S520, the amplitude at which the mechanical vibration device performs mechanical vibration is adjusted by the electric cylinder to be a second amplitude, where the second amplitude is the amplitude of the second mode.

It should be noted that the frequencies and amplitudes of the mechanical vibration in the first mode and the second mode are different. The frequency conversion control cabinet 150 and the electric cylinder 160 can achieve precise adjustment of the mechanical vibration, making the control of the arc additive apparatus 100 more precise, which facilitates the arc additive manufacturing.

It should be noted that, referring to FIG. 2, the mechanical vibration device 120 is provided on the flange 161 of the electric cylinder 160. By moving the electric cylinder 160 up and down, the distance between the mechanical vibration device 120 and the workpiece 173 can be adjusted, thereby adjusting the amplitude of the mechanical vibration.

It can be understood that, referring to FIG. 2, the mechanical vibration device 120 includes at least one motor 121 and at least one vibrator 122. The motor 121 is connected to the vibrator 122, the frequency conversion control cabinet 150 sends a frequency conversion signal to the motor 121, and the rotating speed of the motor 121 is regulated according to the frequency conversion signal, thus implementing the regulation for the frequency of the mechanical vibration between the vibrator 122 and the workpiece 173.

It should be noted that the frequency conversion control cabinet 150 can regulate the rotating speed of the motor 121, thus regulating the frequency of the mechanical vibration between the vibrator 122 and the workpiece 173.

It should be noted that, referring to FIG. 2, the motor 121 is connected to the vibrator 122 through a coupling 123, and the vibrator 122 include a slider 125 and a camshaft 124. The motor 121 rotates to drive the camshaft 124 to rotate, so that the slider 125 fixed to the camshaft 124 continuously make reciprocating motion and collide with the workpiece 173, thereby generating the mechanical vibration. In the embodiments of the present disclosure, the time interval between collisions of the slider 125 with the workpiece 173 is regulated by regulating the rotating speed of the motor 121, thus adjusting the frequency of the mechanical vibration.

It should be noted that different workpieces 173 have different properties in the additive welding process, and can withstand different mechanical vibrations. For different workpieces 173, the mechanical vibrations in the first mode and the second mode are different, but represent the optimal mechanical vibration corresponding to the workpiece 13 in its current situation.

It can be understood that the first frequency ranges from 100 Hz to 150 Hz, and the first amplitude ranges from 50 microns to 80 microns.

It should be noted that the rotating speed of the motor 121, corresponding to the frequency of the mechanical vibration in the first mode, is 6,000 rpm to 9,000 rpm.

It can be understood that the second frequency ranges from 20 Hz to 50 Hz, the second amplitude ranges from 100 microns to 200 microns, and the mechanical vibration in the second mode lasts for 30 s to 60 s.

It should be noted that the rotating speed of the motor 121, corresponding to the frequency of the mechanical vibration in the second mode, is 1,200 rpm to 3,000 rpm.

It should be noted that when the first frequency is 100 Hz, the first amplitude is 80 microns, the rotating speed of the motor 121, corresponding to the frequency of the mechanical vibration in the first mode, is 6,000 rpm, the second frequency is 20 Hz, the second amplitude is 200 microns, the rotating speed of the motor 121, corresponding to the frequency of the mechanical vibration in the second mode, is 1,200 rpm, and the mechanical vibration in the second mode lasts for 60 s.

It should be noted that when the first frequency is 150 Hz, the first amplitude is 50 microns, the rotating speed of the motor 121, corresponding to the frequency of the mechanical vibration in the first mode, is 1,200 rpm, the second frequency is 50 Hz, the second amplitude is 100 microns, the rotating speed of the motor 121, corresponding to the frequency of the mechanical vibration in the second mode, is 3,000 rpm, and the mechanical vibration in the second mode lasts for 30 s.

It should be noted that when the first frequency is 125 Hz, the first amplitude is 65microns, the rotating speed of the motor 121, corresponding to the frequency of the mechanical vibration in the first mode, is 3,600 rpm, the second frequency is 35 Hz, the second amplitude is 150 microns, the rotating speed of the motor 121, corresponding to the frequency of the mechanical vibration in the second mode, is 2,100 rpm, and the mechanical vibration in the second mode lasts for 45 s.

It should be noted that, in the entire welding process of the additive welding gun 110, the mechanical vibration in the first mode continues to act on the workpiece 173, and after the welding of the additive welding gun 110 is completed, the mechanical vibration in the second mode lasts for 30 s to 60 s, so as to diminish the residual stress in the workpiece 173. The mechanical vibration time of the second mode lasts for 30 s to 60 s, which can minimize the energy consumption of the mechanical vibration while diminishing the residual stress of the workpiece 173 significantly.

It should be noted that, by comparison, the mechanical vibration in the first mode is the mechanical vibration of high frequency and small amplitude, while the mechanical vibration in the second mode is the mechanical vibration of low frequency and large amplitude.

It can be understood that, referring to FIG. 2, the ultrasonic auxiliary device 130 includes an ultrasonic generator 131 and two ultrasonic transducers 132. The two ultrasonic transducers 132 are arranged on both sides of the additive welding gun 110 to enhance the ultrasonic field at the droplet transfer, and a signal transmitting end of the ultrasonic generator 131 is connected to the two ultrasonic transducers 132. The ultrasonic generator 131 drives the two ultrasonic transducers 132 to emit ultrasonic waves to the melting position of the wire, so as to form the ultrasonic field. Such arrangement enables the two ultrasonic transducers 132 to emit ultrasonic waves to the melting position of the wire to form the ultrasonic field, so as to regulate the droplet transfer of the wire, further enhancing the stability in the additive welding process and improving the additive efficiency and additive quality. Meanwhile, part of the ultrasonic waves emitted by the ultrasonic transducers 132 will enter the molten pool, the bubbles during the additive manufacturing are reduced due to the ultrasonic stirring effect, and the large crystal grains in the workpiece 173 are broken continuously, so that the crystal grains in the workpiece 173 are continuously refined, thus improving the mechanical properties and molding quality of the additive workpiece 173 and implementing the optimization of the workpiece 173 in additive manufacturing.

It can be understood that the arc additive apparatus 100 further includes a welding machine 175 and a wire feeder 174. Accordingly, the control method for the arc additive apparatus 100 provided in an embodiment of the present disclosure further includes controlling the welding machine 175 to drive the wire feeder 174 to deliver the wire below the additive welding gun 110.

It can be understood that the arc additive apparatus 100 further includes a gas cylinder 176. Before the additive welding gun 110 starts working, the control method for the arc additive apparatus 100 provided in an embodiment of the present disclosure further includes controlling the inert gas in the gas cylinder 176 to be delivered to the additive welding gun 110.

It should be noted that the control method for the arc additive apparatus 100 provided in an embodiment of the present disclosure includes acquiring an additive instruction first, acquiring a wire corresponding to the workpiece to be machined 173 according to the additive instruction, then controlling the ultrasonic auxiliary device 130 to emit ultrasonic waves below the additive welding gun 110 according to the additive instruction, and forming a stable ultrasonic field below the additive welding gun 110 to regulate the droplet transfer of the wire. In addition, the wire forms a molten pool in the melting process, and part of the ultrasonic field acts on the molten pool to stir the molten pool, thus reducing the bubbles in the molten pool and breaking large crystal grains in the solidification process of the molten pool, effectively improving the quality of the arc additive and the stability of the additive process. In the welding process of the additive welding gun 110, the mechanical vibration device 120 performs mechanical vibration in a first mode on the workpiece 173, and the mechanical vibration acts on a mesoscopic level, which can reduce the accumulation of the thermal stress in the additive process. After the welding of the additive welding gun 110 is completed, the mechanical vibration device 120 performs mechanical vibration in a second mode on the workpiece 173, which can reduce and diminish the residual stress in the workpiece 173. The mechanical vibrations in the first and second modes cooperating with each other can reduce the stress in the workpiece 173 significantly, and minimize the occurrence of cracks in products using arc additive manufacturing, thus improving the quality of the products.

An embodiment of the present disclosure further provides an electronic device, including a memory, a processor, and a computer program stored in the memory and executable on the processor. When executing the computer program, the processor implements the control method for the arc additive apparatus 100 from $100 to S500.

The processor may be connected to the memory via a bus or by other means.

As a non-transient computer-readable storage medium, the memory may be used to store non-transient software programs and non-transient computer executable programs. In addition, the memory may include a high-speed random access memory, and may further include a non-transient memory, such as at least one disk storage device, a flash memory, or other non-transient solid-state storage device. In some implementations, the memory may optionally include memories set remotely relative to the processor, and these remote memories may be connected to the processor via networks. Examples of the above networks include but are not limited to the Internet, an intranet, a local area network, a mobile communication network and a combination thereof.

The non-transient software programs and instructions required to implement the control method for the arc additive apparatus 100 in the above embodiments are stored in the memory. When executed by the processor, the control method for the arc additive apparatus 100 in the above embodiments is executed, for example, the method steps S100 to S500 in FIG. 4 described above are performed.

The device embodiments described above are merely illustrative, and the units described as separate parts may or may not be physically separated, that is, they may be located in one location, or may be distributed on a plurality of network units. Some or all of the modules may be selected according to actual needs to achieve the objective of the solution of this embodiment.

In addition, an embodiment of the present disclosure further provides a computer-readable storage medium, which stores computer-executable instructions therein. The computer-executable instructions are executed by a processor or a controller, such that the above processor executes the control method for the arc additive apparatus 100 in the above embodiment, for example, executes the above-described method steps S100 to S500 in FIG. 4, method steps S410 to S420 in FIG. 5, and method steps S510 to S520 in FIG. 6.

Those of ordinary skill in the art may understand that all or some steps and systems in the method disclosed above can be implemented as software, firmware, hardware, and appropriate combinations thereof. Some or all of the physical components may be implemented as software executed by a processor, such as a central processing unit, a digital signal processor or a microprocessor, or as hardware, or as an integrated circuit, such as an application-specific integrated circuit. Such software may be distributed on a computer-readable medium, which may include computer storage media (or non-transient media) and communication media (or transient media). As is known to those of ordinary skills in the art, the term ‘computer storage media’ include volatile and nonvolatile and removable and non-removable media implemented in any method or technology for storing information (such as computer readable instructions, data structures, program modules or other data). Computer storage media include, but are not limited to, a random access memory (RAM), a read-only memory (ROM), an electrically erasable programmable read-only memory (EEPROM), a flash memory or other memory technologies, a compact disc read-only memory (CD-ROM), a digital video disk (DVD) or other optical disk storage, a magnetic cassette, a tape, a disk storage or other magnetic storage devices, or any other media used to store the desired information and accessed by a computer. In addition, it is known to those of ordinary skill in the art that the communication media typically include computer-readable instructions, data structures, program modules or other data in a modulated data signal such as a carrier wave or other transmission mechanisms, and may include any information delivery media.

The embodiments of the present disclosure are described in detail above in combination with the accompanying drawings, but the present disclosure is not limited to the above embodiments. Without departing from the purpose of the present disclosure, various changes may also be made within the knowledge scope of those of ordinary skills in the art. In addition, the embodiments in the present disclosure and features in the embodiments may be combined with each other without conflict.

1. An arc additive apparatus, comprising:
an additive welding gun, configured to melt a wire to perform additive manufacturing on a workpiece to be machined;
a mechanical vibration device, arranged below the workpiece;
an ultrasonic auxiliary device, arranged at a side of the additive welding gun; and
a control device, electrically connected to the additive welding gun, the mechanical vibration device and the ultrasonic auxiliary device, and configured to control the ultrasonic auxiliary device to form an ultrasonic field below the additive welding gun, and to control, when welding at a position where additive manufacturing is to be performed by the additive welding gun, the mechanical vibration device to perform a mechanical vibration in different modes separately during and at the end of a welding process of the additive welding gun.

2. The arc additive apparatus according to claim 1, further comprising a frequency conversion control cabinet and an electric cylinder, wherein a signal transmitting end of the frequency conversion control cabinet is connected to the mechanical vibration device, a drive end of the electric cylinder is connected to the mechanical vibration device, and both the frequency conversion control cabinet and the electric cylinder are electrically connected to the control device.

3. The arc additive apparatus according to claim 2, wherein the mechanical vibration device comprises at least one motor and at least one vibrator, the motor is connected to the vibrator and the signal transmitting end of the frequency conversion control cabinet, and the other end of the vibrator is connected to the workpiece.

4. The arc additive apparatus according to claim 3, wherein a molding table is provided between the vibrator and the workpiece.

5. A control method for an arc additive apparatus, wherein the arc additive apparatus comprises an additive welding gun, a mechanical vibration device and an ultrasonic auxiliary device, the ultrasonic auxiliary device is arranged at a side of the additive welding gun, and the control method comprises:
acquiring an additive instruction;
controlling the ultrasonic auxiliary device to emit ultrasonic waves according to the additive instructions, to form an ultrasonic field below the additive welding gun;
controlling the ultrasonic field to move along a workpiece where additive manufacturing is to be performed;
controlling, in a process that the additive welding gun welds the workpiece, the mechanical vibration device to provide a mechanical vibration for the workpiece according to a first mode; and
controlling, after the additive welding gun finishes welding, the mechanical vibration device to provide a mechanical vibration for the workpiece according to a second mode, wherein the second mode indicates mechanical vibration parameters different from the first mode.

6. The control method according to claim 5, wherein the mechanical vibration parameters comprise a frequency and an amplitude, the frequency of the second mode is less than the frequency of the first mode, and the amplitude of the second mode is greater than the amplitude of the first mode.

7. The control method according to claim 6, wherein the arc additive apparatus further comprises a frequency conversion control cabinet and an electric cylinder,
the controlling the mechanical vibration device to provide a mechanical vibration for the workpiece according to a first mode comprises:
adjusting by the frequency conversion control cabinet the frequency at which the mechanical vibration device performs the mechanical vibration to be a first frequency, wherein the first frequency is the frequency of the first mode; and
adjusting by the electric cylinder the amplitude at which the mechanical vibration device performs the mechanical vibration to be a first amplitude, wherein the first amplitude is the amplitude of the first mode;
the controlling the mechanical vibration device to provide a mechanical vibration for the workpiece according to a second mode comprises:
adjusting by the frequency conversion control cabinet the frequency at which the mechanical vibration device performs the mechanical vibration to be a second frequency, wherein the second frequency is the frequency of the second mode; and
adjusting by the electric cylinder the amplitude at which the mechanical vibration device performs the mechanical vibration to be a second amplitude, wherein the second amplitude is the amplitude of the second mode.

8. The control method according to claim 7, wherein the first frequency ranges from 100 Hz to 150 Hz, and the first amplitude ranges from 50 microns to 80 microns.

9. The control method according to claim 8, wherein the second frequency ranges from 20 Hz to 50 Hz, the second amplitude ranges from 100 microns to 200 microns, and the mechanical vibration in the second mode lasts for 30 s to 60 s.

10. A non-transitory computer storage medium, comprising computer-executable instructions stored therein, wherein the computer-executable instructions are used to execute the control method for an arc additive apparatus according to any one of claims 6 to 9.
